(19) United States
(12) Patent Application Publication
(10) Pub. No.: US 2009/0185483 A1
(43) Pub. Date: Jul. 23, 2009

(54) Method and Apparatus for Transmitting Data and Error Recovery

(75) Inventors: Sean Michael McBeath, Keller, TX (US); Phillip Barber, McKinney, TX (US)

Correspondence Address: Slater & Matsil, L.L.P., 17950 Preston Road, Suite 1000, Dallas, TX, 75252, US

(73) Assignee: FutureWei Technologies, Inc., Plano, TX (US)

(21) Appl. No.: 12/355,267

(22) Filed: Jan. 16, 2009

Related U.S. Application Data
(60) Provisional application No. 61/022,314, filed on Jan. 19, 2008.
(60) Provisional application No. 61/027,861, filed on Feb. 12, 2008.
(60) Provisional application No. 61/028,513, filed on Feb. 13, 2008.

(51) Int. Cl. G06F 11/00; H04W 72/00; H04J 1/00

(52) U.S. Cl. 370/221; 370/329; 370/281

(57) ABSTRACT

A system and method for partitioning and transmitting a frame configuration in a wireless communication system is provided. A preferred embodiment comprises a method for determining a frame configuration in H-FDD systems where multiple time domain groups are supported is disclosed. Another embodiment provides a method for a base station for transmitting an indication of a frame configuration in H-FDD systems where multiple time domain groups are supported. Further, if the mobile stations enter into an error condition because they did not receive the frame configuration, an error recovery process may be utilized to self-recover from the error condition.

This application claims the benefit of U.S. Provisional Application No. 61/022,314, filed on Jan. 19, 2008, entitled “Method and Apparatus for Control Channel Error Recovery in an H-FDD Wireless Communication System,” U.S. Provisional Application No. 61/027,861, filed on Feb. 12, 2008, entitled “Method and Apparatus for Partitioning a Frame in an H-FDD Wireless Communication System,” and U.S. Provisional Application No. 61/028,513, filed on Feb. 13, 2008, entitled “Method and Apparatus for Transmitting a Frame Configuration in an H-FDD Wireless Communication System,” all of which are hereby incorporated herein by reference.

### TECHNICAL FIELD

The present invention relates generally to a system and method transmitting data, and more particularly to a system and method for transmitting packets of data in a wireless communication system.

### BACKGROUND

Generally, in an OFDMA communication system, a frequency division duplex (FDD) base station (BS) is capable of simultaneously transmitting to and receiving from mobile stations (MSs). However, some low cost MSs, like half duplex MSs, are only capable of either transmitting to or receiving from the BS at any given time. Additionally, the BS may establish groups of half duplex frequency division duplex (H-FDD) MSs, wherein each group of H-FDD MSs receives information at a particular time period and transmits information at another particular time period. In some H-FDD systems, the base station may establish two H-FDD groups, where one H-FDD group has its downlink (DL) control channel at a fixed location, and the other H-FDD group has its downlink control channel at a variable location. For MSs belonging to the H-FDD group having the DL control channel at a variable location, the MS determines the location of the DL control channel prior to the DL control channel. If the MS cannot successfully decode the DL control channel containing the location of a DL control channel, an error condition exists.

Additionally, there are mechanisms to partition a frame between the DL and UL in time division duplex (TDD) systems, but these mechanisms have not been used in H-FDD systems. In order for H-FDD systems to be backwards compatible with the message structure of TDD systems, a method of bridging the systems would be beneficial.

### SUMMARY OF THE INVENTION

These and other problems are generally solved or circumvented, and technical advantages are generally achieved, by preferred embodiments of the present invention which provide for the transmission of data and also for error recovery if that transmission is faulty.

In accordance with a preferred embodiment of the present invention, a method for receiving data comprises providing a mobile station and receiving an assignment message wirelessly at the mobile station to be grouped into a first group, the first group being different from a second group. A first control message is received at the mobile station containing an indication of a first duration, the first duration being a duration for a transmission intended for either the first group or the second group. A location of a second control message is determined from the first duration, and the second control message is received at the determined location.

In accordance with another preferred embodiment of the present invention, a method for transmitting data comprises transmitting a first control message comprising a first number of symbols to a first group of mobile stations and a second group of mobile stations. A location of a second control message is determined from the first number of symbols, and the second control message is transmitted to the second group of mobile stations at the determined location.

In accordance with yet another preferred embodiment of the present invention a method in a base station for transmitting an indication of a frame configuration in a half duplex frequency division duplex (H-FDD) system comprises providing a first H-FDD group and a second H-FDD group and transmitting a frame comprising a number of OFDM symbols. A first control message is transmitted, the first control message comprising a first indication of a number of downlink symbols for the first H-FDD group relative to a beginning of the frame. A second control message is transmitted, the second control message comprising a second indication of the number of downlink symbols for the second H-FDD group relative to the end of the frame. The second control message is retransmitted at a first location, the first location determined by subtracting the number of downlink symbols for the second H-FDD group from the number of OFDM symbols

In accordance with yet another preferred embodiment of the present invention, a method for error recovery comprises providing a first mobile station in a first group of one or more mobile stations, and it is determined whether an error condition exists. If an error condition exists, the first mobile station switches to a second group of one or more mobile stations and receives a control message for the second group of one or more mobile stations. After receiving the control message, the first mobile station switches to the first group of one or more mobile stations.

In accordance with yet another preferred embodiment of the present invention, a method in a mobile station for recovering from an error event in a half duplex frequency division duplex (H-FDD) system comprises determining an H-FDD group assignment from a plurality of possible H-FDD group assignments, at least one of the H-FDD groups having a first control channel at a fixed location and at least one of the H-FDD groups having a second control channel at a variable location, and attempting to process the control channel for the determined group assignment. It is then determined whether the control channel was successfully received and, if the determined H-FDD group assignment has its control channel at a fixed location, processing the control channel in the H-FDD group having its control channel at a fixed location.

An advantage of a preferred embodiment of the present invention is allowing for the backwards compatibility of the H-FDD system while also allowing for better error recovery.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a wireless communications network in accordance with an embodiment of the present invention;

FIG. 2 illustrates a base station and several mobile stations from a wireless communications network in accordance with an embodiment of the present invention;

FIG. 3 illustrates an example set of orthogonal frequency division multiple access (OFDMA) time-frequency radio resources in accordance with an embodiment of the present invention;

FIG. 4 illustrates an example time domain structure for H-FDD operation in accordance with an embodiment of the present invention;

FIG. 5 illustrates example assignment messages for H-FDD operation in accordance with an embodiment of the present invention;

FIG. 6 illustrates an example control channel message in accordance with an embodiment of the present invention;

FIGS. 7a-7c illustrate example transition gap locations for an H-FDD system in accordance with an embodiment of the present invention;

FIG. 8 illustrates a repeating sequence of frames in accordance with an embodiment of the present invention;

FIG. 9 illustrates a process flow for the operation of a mobile station in accordance with an embodiment of the present invention;

FIG. 10 illustrates a process flow for the operation of a base station in accordance with an embodiment of the present invention;

FIG. 11 illustrates a process flow for the operation of a mobile station in accordance with one embodiment of the present invention;

FIG. 12 illustrates a process flow for the operation of a base station in accordance with one embodiment of the present invention;

FIG. 13 illustrates group example assignments in accordance with an embodiment of the present invention; and

FIG. 14 illustrates a process flow for the operation of a mobile station operation to recover from an error condition in accordance with an embodiment of the present invention.

Corresponding numerals and symbols in the different figures generally refer to corresponding parts unless otherwise indicated. The figures are drawn to clearly illustrate the relevant aspects of the preferred embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a method and apparatus for partitioning and transmitting a frame configuration in an H-FDD wireless communication system. The invention may also be applied, however, to other data transmission systems.

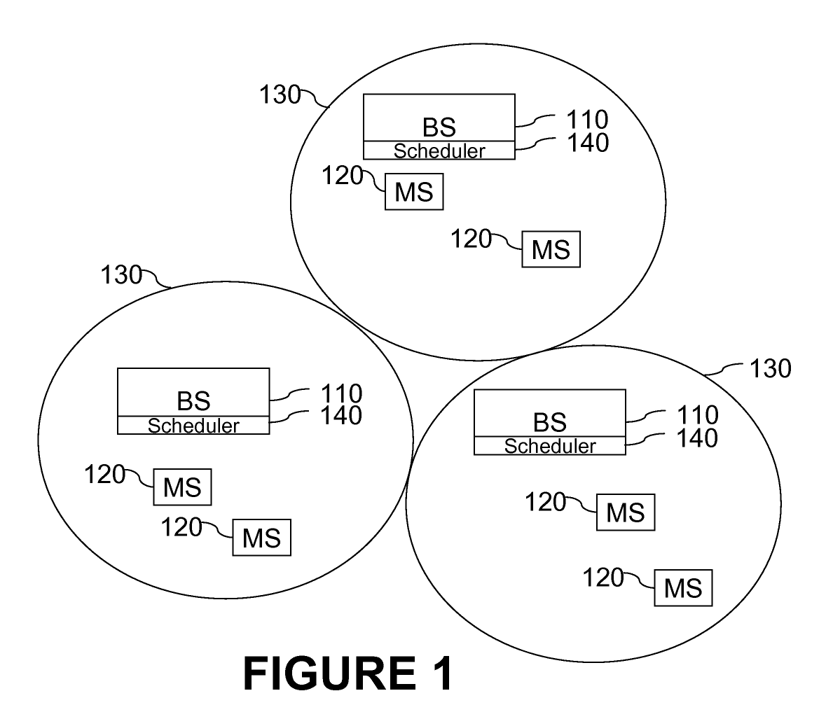

With reference now to FIG. 1, there is shown a wireless communications network which preferably comprises a plurality of base stations (BS) 110 providing voice and/or data wireless communication service to a plurality of mobile stations (MSs) 120. The BSs 110, which may also be referred to by other names such as access network (AN), access point (AP), Node-B, etc., preferably downlink (DL) information to the MSs 120 while also receiving uplink (UL) information from the MSs 120.

Each BS 110 preferably has a corresponding coverage area 130. These coverage areas 130 represent the range of each BS 110 to adequately transmit data, and, while not necessarily shown in FIG. 1, the coverage areas 130 of adjacent BSs 110 preferably have some overlap in order to accommodate handoffs between BSs 110 whenever a MS 120 exits one coverage area 130 and enters an adjacent coverage area 130. Each BS 110 also preferably includes a scheduler 140 for allocating radio resources to the MSs 120.

Preferably, the wireless communications network includes, but is not limited to, an orthogonal frequency division multiple access (OFDMA) network such as an Evolved Universal Terrestrial Radio Access (E-UTRA) network, an Ultra Mobile Broadband (UMB) network, or an IEEE 802.16 network. However, as one of ordinary skill in the art will recognize, the listed networks are merely illustrative and are not meant to be exclusive. Any suitable multiple access scheme network, such as a frequency division multiplex access (FDMA) network wherein time-frequency resources are divided into frequency intervals over a certain time interval, a time division multiplex access (TDMA) network wherein time-frequency resources are divided into time intervals over a certain frequency interval, a code division multiplex access (CDMA) network wherein resources are divided into orthogonal or pseudo-orthogonal codes over a certain time-frequency interval, or the like may alternatively be used.

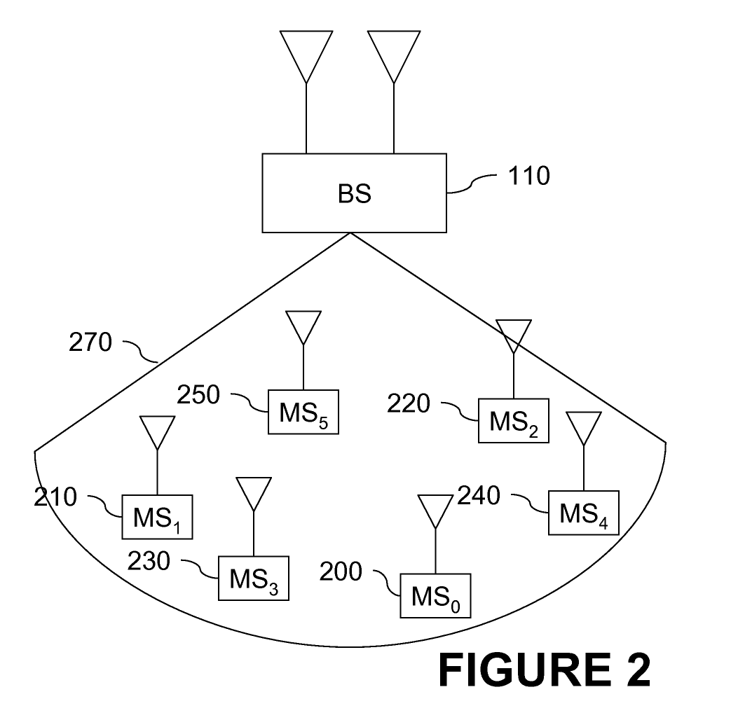

FIG. 2 illustrates one BS 110 and several MSs 120 from the wireless communications network of FIG. 1. As illustrated, the coverage area 130 shown in FIG. 1 is preferably divided into three reduced coverage areas 270, one of which is shown in FIG. 2. Six MSs 120 illustrated in FIG. 1 are individually shown in the reduced coverage area 270 as MS₀200, MS₁ 210, MS₂ 220, MS₃ 230, MS₄ 240, and MS₅ 250. The BS 110 typically assigns each of these MSs 120 one or more connection identifiers (CID) (or another similar identifier) to facilitate time-frequency resource assignments. The CID assignments are preferably transmitted from the BS 110 to MS₀ 200, MS₁ 210, MS₂ 220, MS₃ 230, MS₄ 240, and MS₅ 250 on a control channel, although the CID assignments can alternatively be permanently stored at the MSs 120, or else can be derived based on a parameter of either the MSs 120 or BS 110.

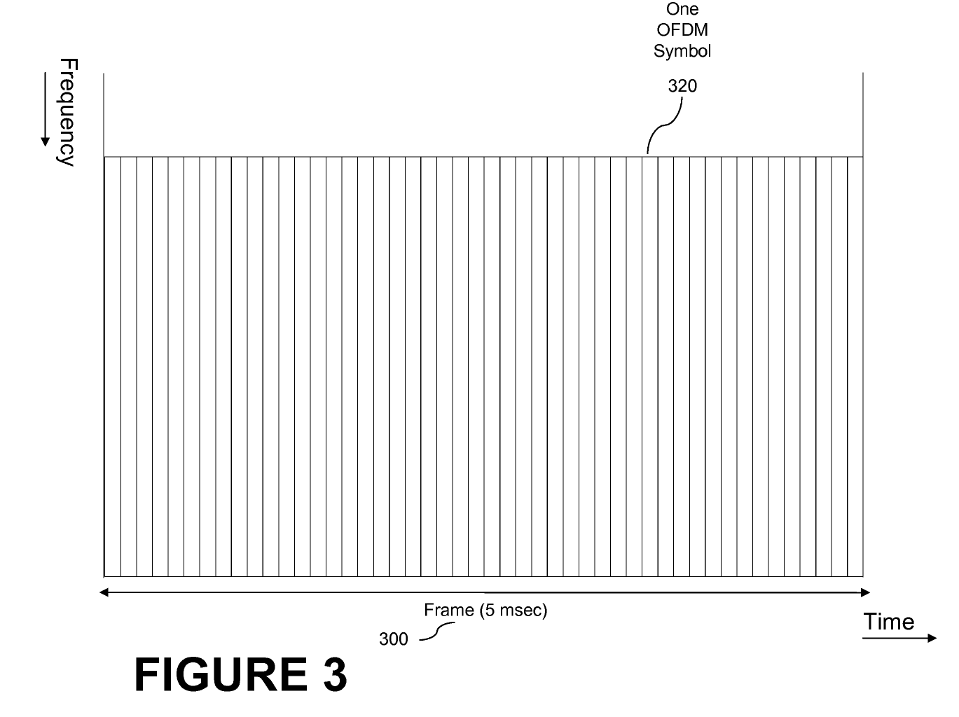

FIG. 3 illustrates a preferred embodiment of OFDMA time-frequency radio resources. In OFDMA systems, the time-frequency resources are preferably divided into OFDM symbols 320 and OFDM subcarriers for allocation to the MSs 120 by the BS 110 scheduler 140. In an example OFDMA system, the OFDM subcarriers are preferably approximately 10 kHz apart and the duration of each OFDM symbol is approximately 100 μs.

Preferably, the OFDM symbols 320 and OFDM subcarriers form one frame 300, such as a frame defined by the IEEE 802.16e standard. The frame 300 is preferably 5 ms in duration, although other durations may alternatively be used.

In this exemplary embodiment, the resources in the time domain (represented by the x-axis) are preferably divided into 48 OFDM symbols 320. In the frequency domain (represented by the y-axis), the resources are divided into multiple subchannels (not shown), wherein the size of each subchannel is dependent at least in part on a chosen subcarrier permutation scheme, which is a mapping from logical subchannels to physical subcarriers. Preferred subcarrier permutation schemes include Downlink (DL) partial usage of subcarriers (PUSC), DL full usage of subcarriers (FUSC), or uplink (UL) PUSC, all defined in the IEEE 802.16 standard. However, this list is meant to be merely illustrative, and any suitable subcarrier permutations may alternatively be used.

As one example of a preferred embodiment, if DL PUSC is chosen as the preferred subcarrier permutation scheme for a 5 MHz bandwidth, there are preferably 360 data subcarriers that are divided into 15 subchannels. Each of these 15 subchannels preferably has 24 data subcarriers. Furthermore, if DL PUSC is chosen, the BS 110 preferably assigns an even number of OFDM symbols 320 for each subchannel.

As another example of a preferred embodiment, if DL FUSC is chosen as the preferred subcarrier permutation scheme for a 5 MHz bandwidth, there are preferably 384 data subcarriers that are divided into 8 subchannels. Furthermore, each of these 8 subchannels preferably has 48 data subcarriers.

As yet another example of a preferred embodiment, if UL PUSC is chosen as the preferred subcarrier permutation scheme for a 5 MHz bandwidth, there are preferably 408 subcarriers (data subcarriers plus pilot subcarriers) divided into 17 subchannels. Furthermore, each of these 17 subchannels preferably has 24 subcarriers (16 data subcarriers plus 8 pilot subcarriers). In this preferred embodiment, the number of OFDM symbols 320 for each subchannel is preferably a multiple of 3.

Preferably, the subchannels are a logical representation of the time-frequency resources of the system and each logical time-frequency resource (subchannel) preferably maps to a physical time-frequency resource. The mapping of logical time-frequency resources to physical time-frequency resources depends at least in part on which subcarrier permutation is chosen to be used along with one or more parameters defined by the system. Furthermore, the mapping of logical time-frequency resource to physical time-frequency resources may be dynamic and changing with time.

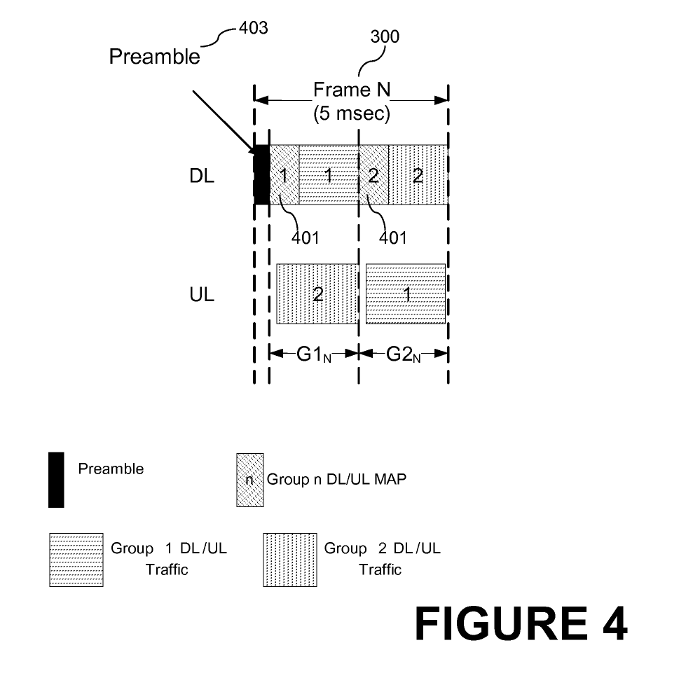

FIG. 4 illustrates a preferred time domain structure that may be used for a preferred H-FDD operation. In this structure, the BS 110 preferably groups the MSs 120 into two or more groups, denoted on FIG. 4 as Group 1 and Group 2. The BS 110 preferably distributes the set of MSs 120 to the available H-FDD groups. This grouping may be random, explicitly assigned, or implicitly assigned. After a MS 120 is initially assigned to either Group 1 or Group 2, the MS 120 preferably monitors only the control channels corresponding to that group.

For each frame 300 transmitted, both Group 1 and Group 2 preferably monitor the system preamble 403. Both Group 1 and Group 2 DL are preferably preceded by a control message 401, or MAP, applicable to the MSs 120 assigned to that particular group. The control message 401 preferably contains both a DL control channel and a UL control channel. The DL control message 401 may be transmitted every frame 300 or alternatively may be transmitted only as needed by the BS 110. The DL control message 401 may be the DL-MAP as defined by the 802.16e standard, although, alternatively, the downlink channel descriptor (DCD) as defined by the 802.16e standard may also be used.

On the DL, the BS 110 first preferably transmits only to Group 1 and then to Group 2 within the frame 300. This order is preferably reversed on the UL, such that the BS 110 first receives from Group 2 and then receives from Group 1 in the frame 300. In this manner, the MSs 120 in Group 1 may be on the UL while the MSs 120 in Group 2 is on the DL, and both Group 1 and Group 2 are not transmitting and receiving at the same time.

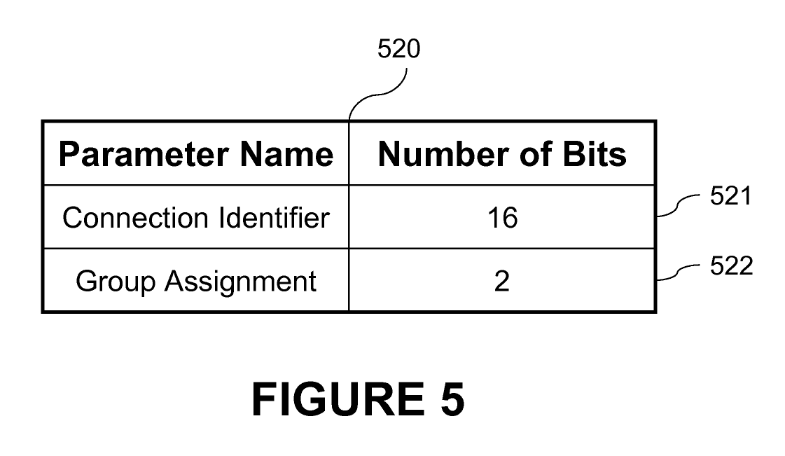

FIG. 5 illustrates a preferred example group assignment message 520 for conveying group assignments to the MS 120 (e.g., assigning MS₅ 250 to Group 2) when an explicit assignment is made. Preferably, the BS 110 transmits the group assignment message 520 with a connection identifier 521 to the intended MSs 120, wherein the connection identifier 521 is preferably a 16 bit field which uniquely identifies the MSs 120 to be assigned. The group assignment message 520 also preferably comprises a group assignment field 522, which is preferably 2 bits, in order to indicate the group in which the MSs 120 are assigned.

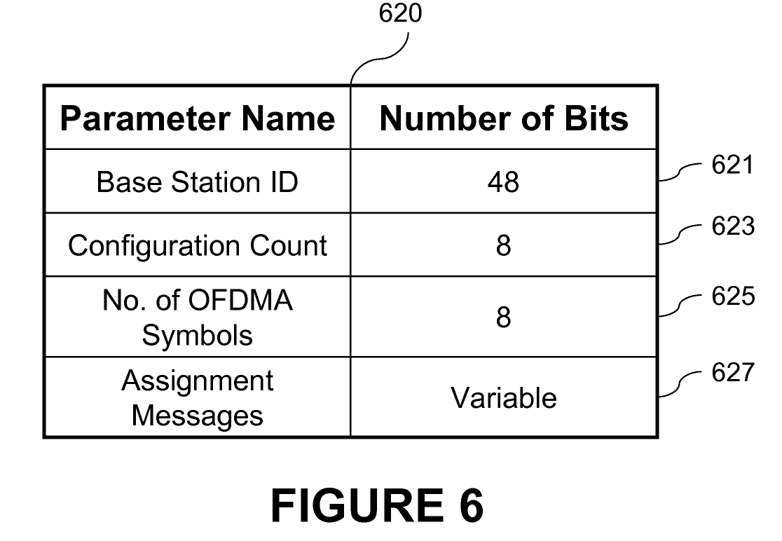

FIG. 6 illustrates a preferred control channel message 620 which may be used as the control message 401 discussed above with respect to FIG. 4 and into which the group assignment message 520 may be inserted. The control channel message 620 preferably comprises a 48-bit Base Station ID field 621, an 8-bit Configuration Count field 623, an 8-bit number of OFDMA symbols field 625 (which may be used in TDD systems for indicating the division between the DL and the UL), although the control channel message 620 may also include additional information. The control channel message 620 also preferably comprises zero or more variable assignment messages 627 similar to the group assignment messages 520 described above with respect to FIG. 5. The control channel message 620 may be a DL-MAP message as defined by the 802.16e standard.

In TDD systems, the number of OFDMA symbols field 625 is used for indicating the division between the DL and the UL. However, in an effort to maintain backward compatibility and maintain signaling efficiency, it is preferable to reuse the number of OFDMA symbols field 625 for H-FDD operation. In some embodiments, a similar message may be used for UL operation.

Referring again to FIG. 4, MSs 120 in Group 1 preferably have a time domain frame structure very similar to MSs 120 in a TDD, such that the interpretation of the number of OFDMA symbols 320 in the DL and UL is similar to TDD operation. For example, for DL operation, the number of OFDMA symbols field 625 for MSs 120 in Group 1 is preferably relative to the first OFDMA symbol 320 of the frame 300 (e.g., the beginning of the frame 300). In particular, if a MS 120 in Group 1 receives the control channel message 620, the MS 120 in Group 1 can determine that the length of the DL subframe is indicated by the number of OFDMA symbols field 625 beginning from the first OFDMA symbol 320 in the frame 300 and continuing for the number of OFDMA symbols 320 represented by the number of OFDMA symbols field 625.

However, for MSs 120 assigned to Group 2, a new procedure is preferably used for interpreting the number of OFDMA symbols 320 in the DL and UL. In an embodiment the number of OFDMA symbols field 625 for MSs 120 in Group 2 is preferably relative to the last OFDMA symbol 320 of the frame 300 (e.g., the end of the frame 300). In particular, if a MS 120 in Group 2 receives the control channel message 620, the MS 120 in Group 2 can determine the length of the DL subframe from the number of OFDMA symbols field 625 and continuing backwards from the last OFDMA symbol 320 in the frame 300 for the number of OFDMA symbols 320 represented by the number of OFDMA symbols field 625.

Furthermore, having the MSs 120 in Group 1 be related to the first ODFMA symbol 320 in Frame N and the MSs 120 in Group 2 being related to the last ODFMA symbol 320 in Frame N is not the only association that may be used. Alternatively, the number of OFDMA symbols field 625 in the UL control message, not shown, for MSs 120 in Group 1 may be relative to the end of the frame 300, and the number of OFDMA symbols field 625 in the UL control message, not shown, for MSs 120 in Group 2 may be relative to the beginning of the frame 300.

However, this procedure is not the only procedure that MSs 120 in Group 2 can utilize to determine the beginning of the DL for Group 2. In another embodiment, the number of OFDMA symbols field 625 for MSs 120 in Group 2 may be a relative offset from the beginning of the frame 300. In this embodiment, the actual number of OFDMA symbols 320 in the DL subframe is determined as the difference between the total number of OFDMA symbols 320 in the frame 300 minus the relative offset.

In yet another embodiment, the BS 110 preferably transmits identical content to MSs 120 in both Group 1 and Group 2. In this embodiment the number of OFDMA symbols field 625 is preferably directly applicable for MSs 120 in Group 1. However, the MSs 120 in Group 2 may determine their starting OFDMA symbol 320 based upon this number of OFDMA symbols field 625.

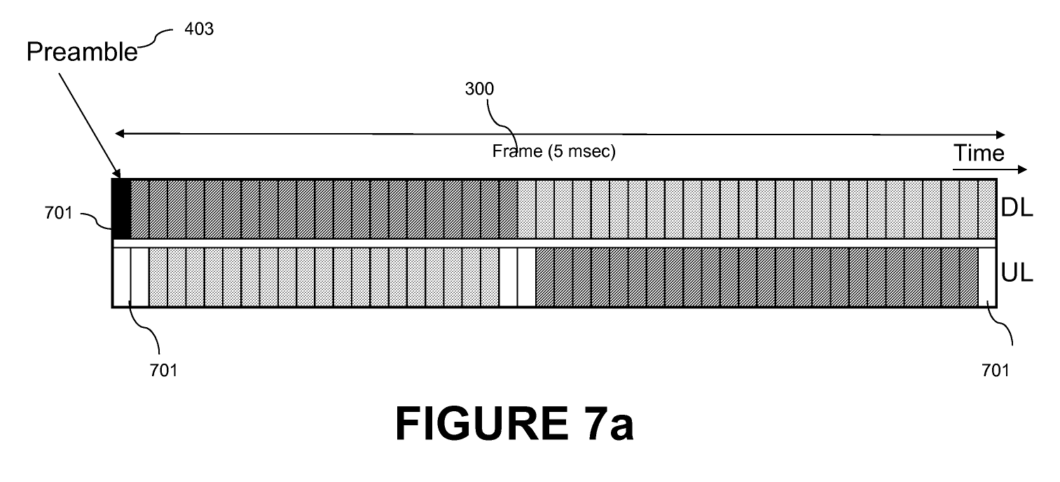

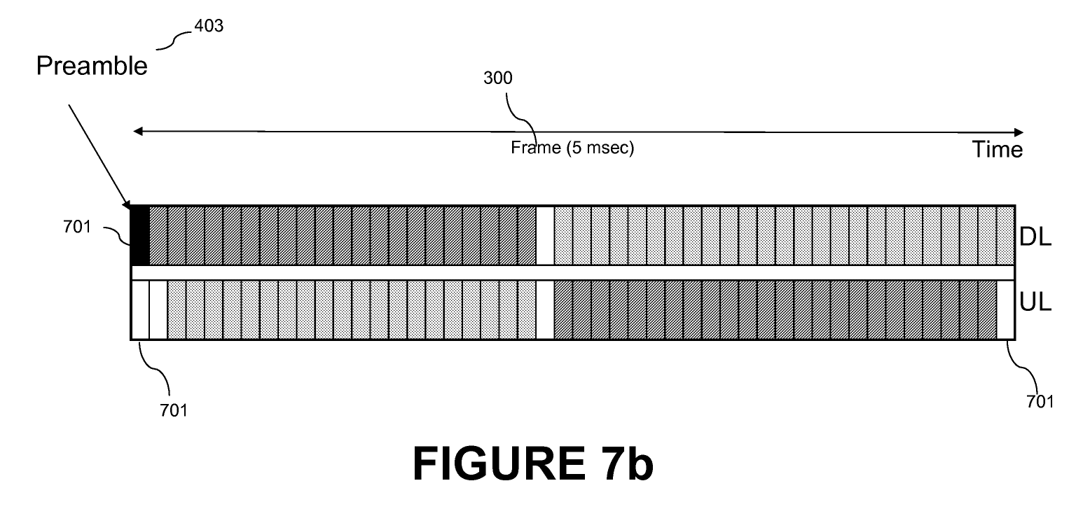

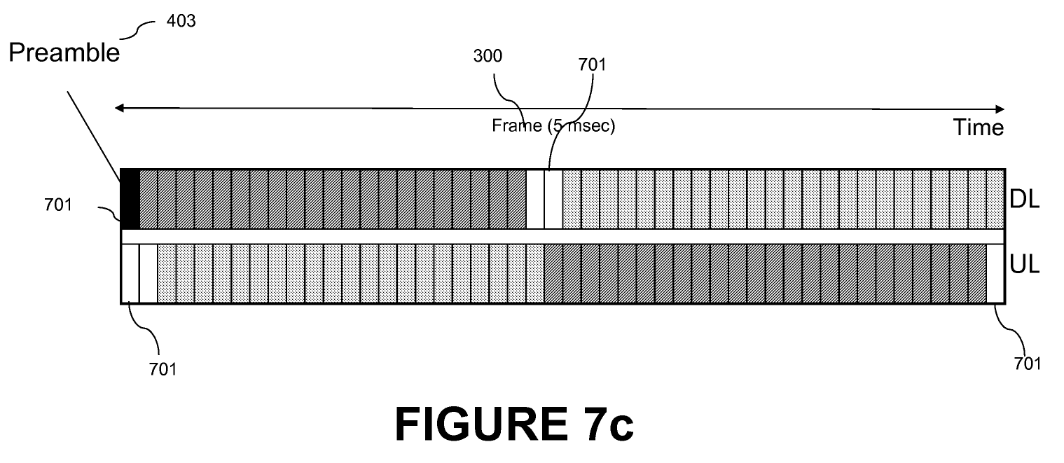

FIGS. 7a-7c illustrate multiple options for the placement of transition gaps 701 within the UL and DL transmissions for H-FDD operation. These multiple options allow the MSs 120 to transition from transmitting to receiving. In each of the options illustrated in FIGS. 7A-7C, there is a first transition gap 701 in the UL at the beginning of each frame and at the end of each frame due to the system preamble 403 which all MSs 120 preferably monitor.

FIG. 7a illustrates the placement of another transition gap 701 between Group 1 (represented in FIGS. 7a-7c as dark gray) and Group 2 (represented in FIGS. 7a-7c as light gray) in the UL. FIG. 7b illustrates the placement of transition gaps 701 between Group 1 and Group 2 in both the DL and UL. FIG. 7c illustrates the placement of transition gaps 701 between Group 1 and Group 2 in the DL. These different placements allow for different amounts of traffic on the DL and UL, and also allow the BS 110 to match the number of OFDMA symbols 320 in a particular link to the subcarrier permutation requirements.

Additionally, if more than one of the placements is supported by the BS 110 and the MSs 120, then the BS 110 preferably indicates to the MSs 120 which placement should be utilized, preferably by signaling the placement using the control channel message 620. In some embodiments, the signaling is preferably performed by adding a new placement field to the control channel message 620. For example, the placement field may be added to the DL-MAP message of the 802.16 standard, where the placement field is only applicable to FDD systems.

Preferably, the BS 110 uses the number of OFDMA symbols field 625 in the DL control messages and the UL control messages to configure the frame 300 according to the desired transition gaps 701 as illustrated in FIGS. 7a-7c. For example, some of the transition gaps 701 may be in fixed locations, while other transition gaps 701 may be in variable locations, depending upon the actual value of the number of OFDMA symbols fields 625 for Group 1 and Group 2. For transition gaps 701 in a fixed location, the MSs 120 and the BS 110 may consider either the end of the frame 300 for determining a starting location as described earlier or else the end of the frame 300 prior to the transition gaps 701.

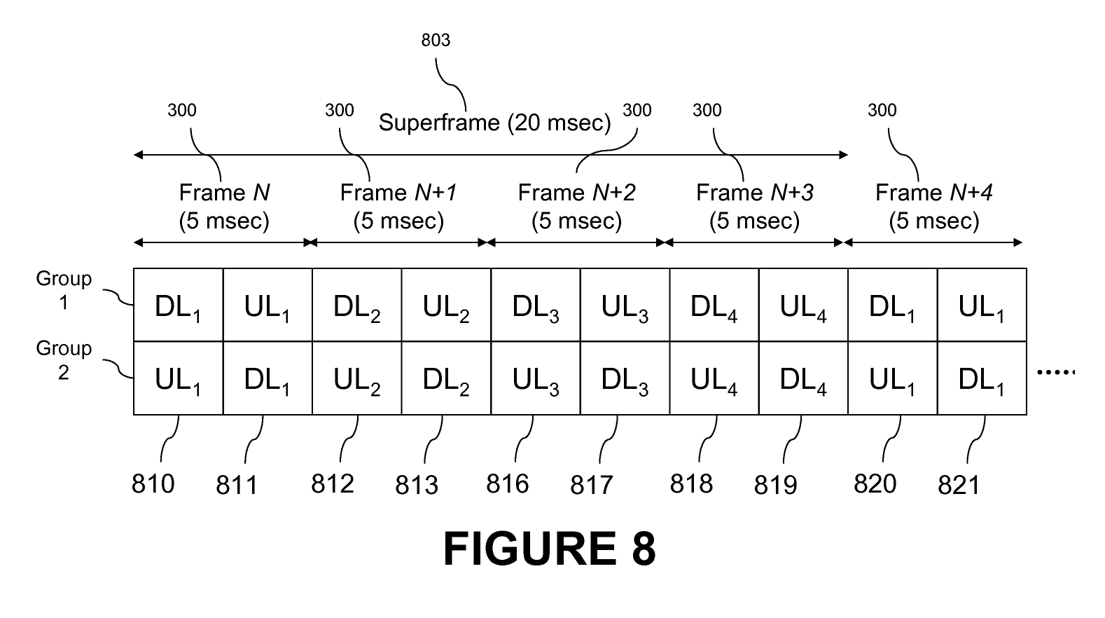

FIG. 8 illustrates a repeating sequence of frames 300 beginning with Frame N. The frames preferably have a duration of 5 msec and contain both DL and UL subframes. A superframe 803 is preferably 20 msec and contains four frames 801 (four pairs of DL and UL subframes). For MSs 120 in Group 1, the first DL subframe is denoted DL₁ 810, the second DL subframe is denoted DL₂ 812, the third DL subframe is denoted DL₃ 816, the fourth DL subframe is denoted DL₄ 818, and the fifth DL subframe is a repeated DL₁ 820. Similarly, for MSs 120 in Group 1, the first UL subframe is denoted UL₁ 811, the second UL subframe is denoted UL₂ 813, the third UL subframe is denoted UL₃ 817, the fourth UL subframe is denoted UL₄ 819, and the fifth UL subframe is a repeated UL₁ 821. For MSs 120 in Group 2, the first DL subframe is denoted DL₁ 811, the second DL subframe is denoted DL₂ 813, the third DL subframe is denoted DL₃ 817, the fourth DL subframe is denoted DL₄ 819, and the fifth DL subframe is a repeated DL₁ 821. Similarly, for MSs 120 in Group 2, the first UL subframe is denoted UL₁ 810, the second UL subframe is denoted UL₂ 812, the third UL subframe is denoted UL₃ 816, the fourth UL subframe is denoted UL₄ 818, and the fifth UL subframe is a repeated UL₁ 820. In this embodiment, the timing is preferably tied to the superframe 803 and preferably repeats every 20 msec. Further, the DL subframes and UL subframes are preferably physically located on separate frequencies.

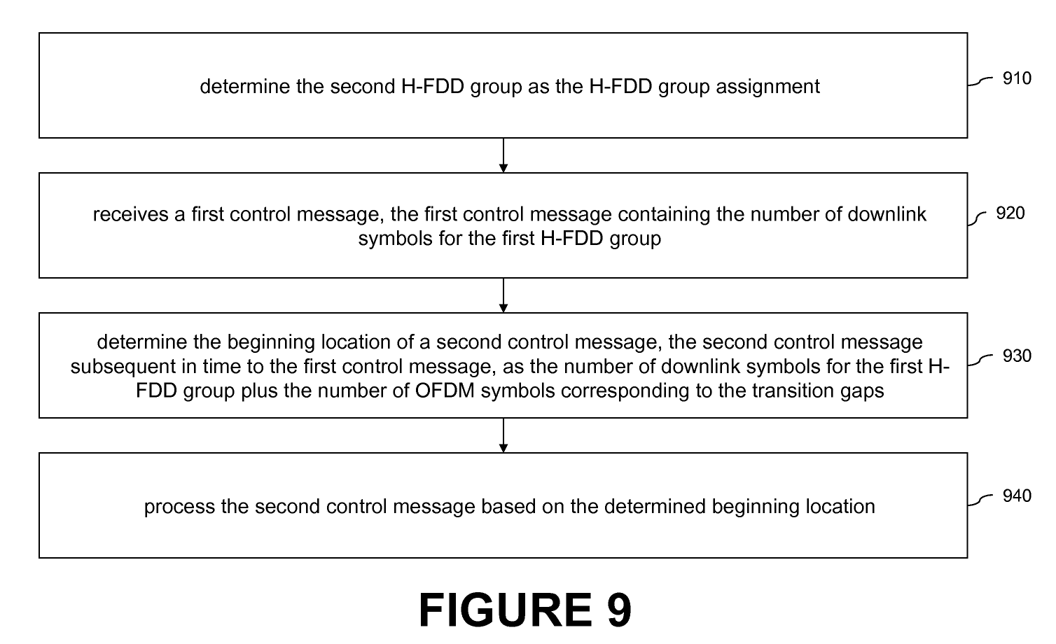

FIG. 9 illustrates a preferred process flow for operation of the MS 120 in accordance with one embodiment of the present invention. At step 910, the MS 120 preferably determines that it is assigned to the second H-FDD group as the H-FDD group assignment (e.g., Group 2 described above with respect to FIG. 4). The MS 120 preferably makes this determination based upon either the reception of, for example, the group assignment message 520 (described above with respect to FIG. 5), or based upon a random selection of group during initial acquisition, or based upon reception of a control channel message 620 (described above with respect to FIG. 6) in a particular H-FDD group, or the like.

At step 920, the MS 120 preferably receives a first control message (e.g., a first control message 401) containing the number of DL OFDM symbols 320 for the first H-FDD group (e.g., Group 1). In some embodiments, the first control message is the DL-MAP message of the 802.16 standard. At step 930, the MS 120 preferably determines the beginning location of a second control message (e.g., another control message 401), the second control message preferably being transmitted subsequent in time to the first control message, as the number of DL OFDM symbols 320 for the first H-FDD group plus the number of OFDM symbols 320 corresponding to the transition gaps 701. At step 940, the MS 120 preferably receives and processes the second control message based upon the location determined in step 930.

In some embodiments, the first control message and the second control message are preferably located in the same frame 300. For example, the first control channel message 620 can be located in the DL of H-FDD Group 1 and the second control channel message 620 can be located in the DL of H-FDD Group 2.

However, in alternative embodiments, the first control message and the second control message may be separately located in a first frame and a second frame. For example, the first control channel message 620 can be located in the DL of H-FDD group in a first frame 300 N, and the second control channel message can be located in the DL of H-FDD group in the next frame 300 N+1. In this way, the first control channel message 620 preferably contains an indication of the location of the second control channel message 620 in a subsequent frame. In some embodiments, the length and location of the UL for the second H-FDD group may be determined in a similar manner, based upon the number of OFDMA symbols 320 in the UL for a first H-FDD group.

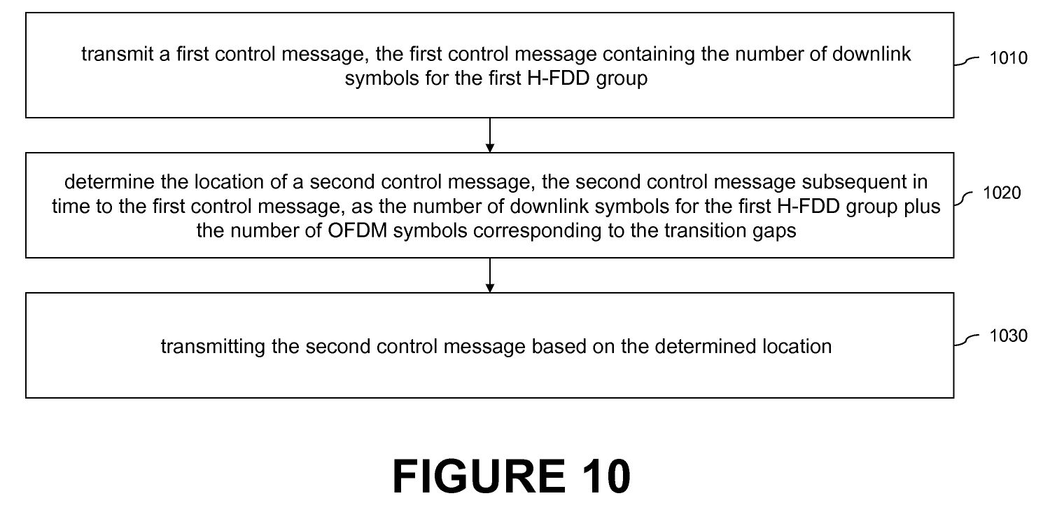

FIG. 10 illustrates a preferred process flow for operation of the BS 110 in accordance with another embodiment of the present invention. At step 1010, the BS 110 preferably transmits a first control message (e.g., a first control message 401), the first control message containing the number of DL OFDM symbols 320 for the first H-FDD group (e.g., Group 1). At step 1020, the BS 110 preferably determines the location of a second control message (e.g., another control message 401), the second control message subsequent in time to the first control message, as the number of DL OFDM symbols 320 for the first H-FDD group plus the number of OFDM symbols 320 corresponding to the transition gaps 701. At step 1030, the BS 110 preferably transmits the second control message based upon the determined location.

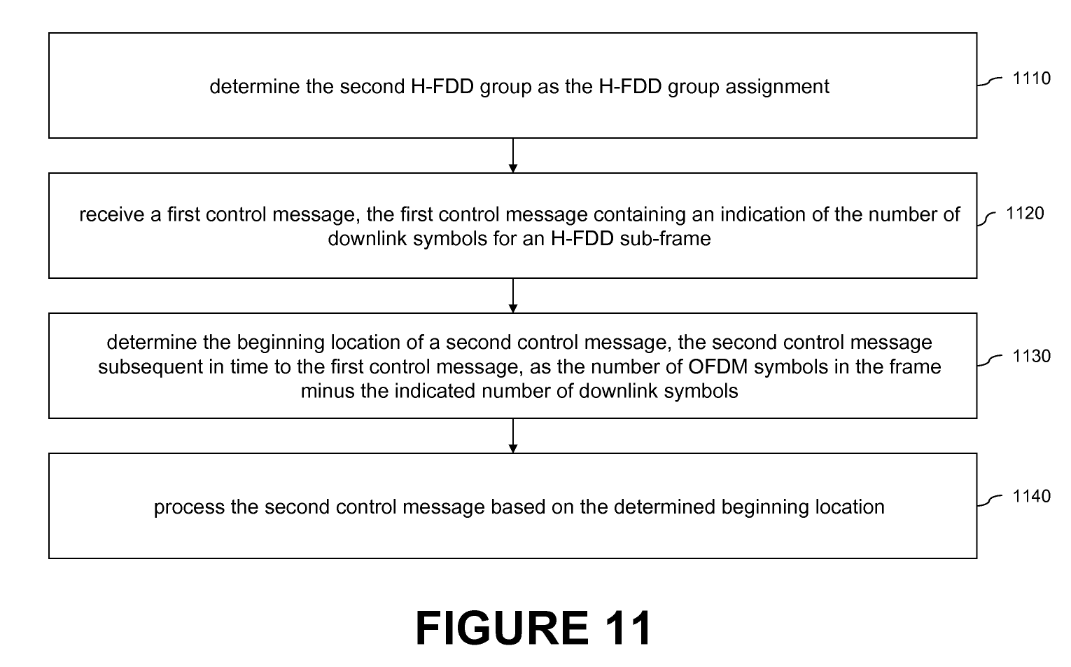

FIG. 11 illustrates a preferred process flow for operation of the MS 120 in accordance with another embodiment of the present invention. In step 1110 the MS preferably determines that it is assigned to the second H-FDD group as the H-FDD group assignment (e.g., Group 2 described above with respect to FIG. 4). The MS 120 preferably makes this determination based upon either the reception of, for example, the group assignment message 520 (described above with respect to FIG. 5), or based upon a random selection of group during initial acquisition, or based upon reception of a control channel message 620 (described above with respect to FIG. 6) in a particular H-FDD group, or the like.

At step 1120, the MS 120 preferably receives a first control message (e.g., control message 401), the first control message containing an indication of the number of DL OFDM symbols 320 for an H-FDD sub-frame. In some embodiments, the first control message may be the DL-MAP message of the 802.16 standard. At step 1130, the MS 120 preferably determines the beginning location of a second control message (e.g., another control message 401), the second control message subsequent in time to the first control message, as the total number of OFDM symbols 320 in the frame minus the indicated number of DL OFDM symbols 320.

At step 1140, the MS 120 preferably processes the second control message based on the determined beginning location. In some embodiments, the first and second control messages are located in the same frame. For example, the first control channel message 620 can be located in the DL of H-FDD Group 1 and the second control channel message 620 can be located in the DL of H-FDD Group 2.

In an alternative embodiment, the first control message and the second control message may be located in a first and second frame. For example, the first control channel message 620 can be located in the DL of H-FDD group in a first frame 300 N, and the second control channel message 620 can be located in the DL of H-FDD group in the next frame 300 N+1. In this way, the first control channel message 620 preferably contains an indication of the location of the second control channel message 620 in a subsequent frame. In some embodiments, the length and location of the UL for the second H-FDD group may be determined in a similar manner.

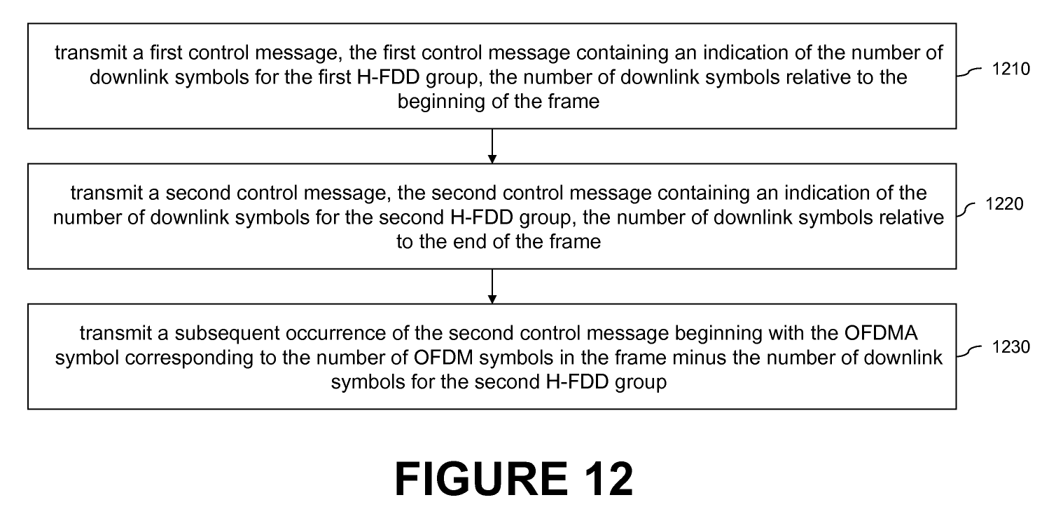

FIG. 12 illustrates a preferred process flow for operation of the BS 110 in accordance with another embodiment of the present invention. At step 1210, the BS 110 preferably transmits a first control message (e.g., control message 401), the first control message containing an indication of the number of DL OFDM symbols 320 for the first H-FDD group (e.g., Group 1), the number of DL symbols 320 preferably being relative to the beginning of the frame. At step 1220, the BS 110 preferably transmits a second control message (e.g., another control message 401), the second control message containing an indication of the number of DL OFDM symbols 320 for the second H-FDD group, the number of DL OFDM symbols 320 preferably being relative to the end of the frame. At step 1230, the BS 110 preferably transmits a subsequent occurrence of the second control message beginning with the OFDMA symbol 320 corresponding to the number of OFDM symbols 320 in the frame minus the number of DL OFDM symbols 320 for the second H-FDD group.

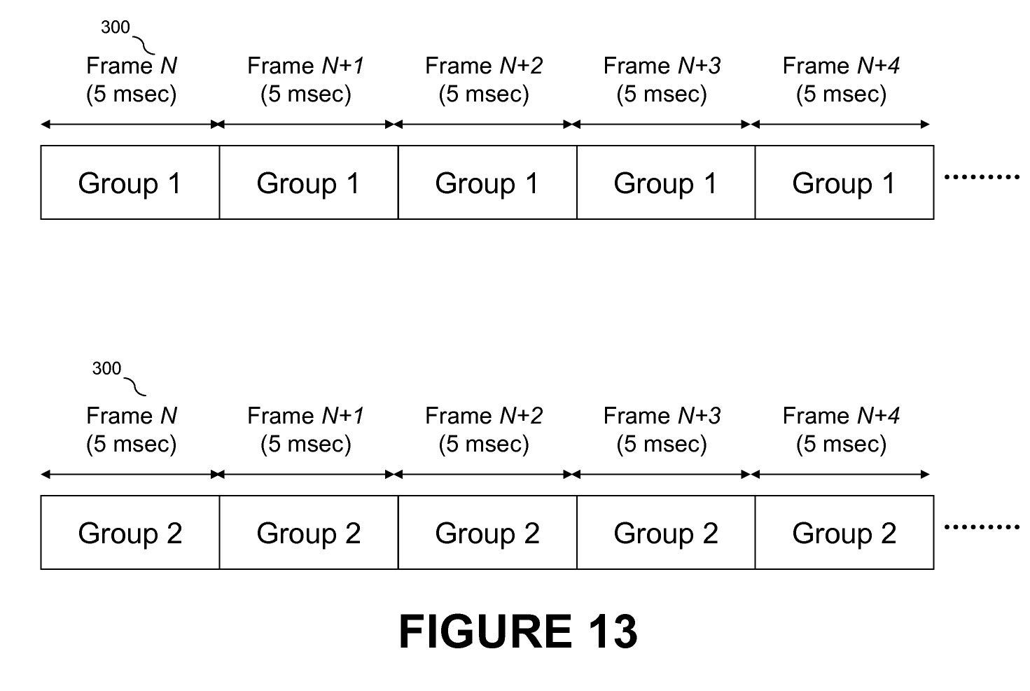

However, even using the above described methodology, it is possible for one or more of the MSs 120 assigned to Group 2 to fail to adequately receive the control messages 401, in which case an error condition exists where the MS 120 assigned to Group 2 does not know when the next control message 401 will be transmitted. FIG. 13 illustrates a preferable group assignment whereby MSs 120 are assigned to either Group 1 or Group 2 for each of frame N, N+1, N+2, etc.

During normal operation, the MSs 120 preferably remain within their assigned groups and do not autonomously switch between Group 1 and Group 2. However, when an error event occurs, the MS 120 in the error condition preferably autonomously switches from Group 2 to Group 1. While in Group 1 the MS 120 preferably receives the next control message 401 in order to self-adjust and recover from the error condition prior to switching back to Group 2.

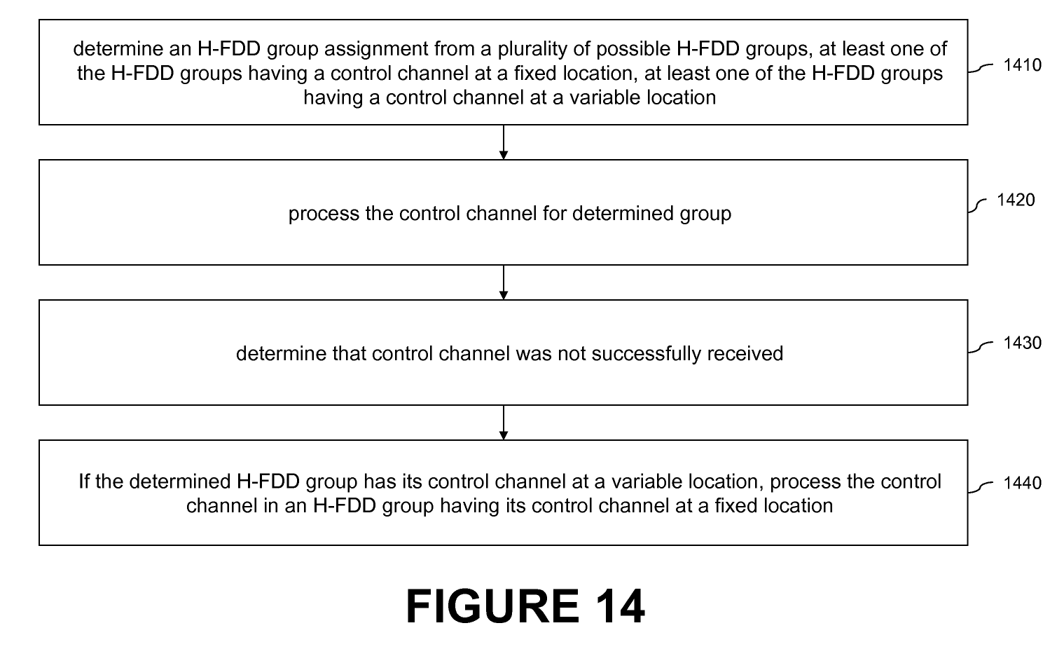

FIG. 14 illustrates a preferred process flow for operation of a MS 120 in accordance with one embodiment of the present invention. At step 1410, the MS 120 preferably determines an initial H-FDD group assignment from a plurality of possible H-FDD groups, at least one of the H-FDD groups having a control channel at a fixed location (e.g., Group 1) and at least one of the H-FDD groups having a control channel at a variable location (e.g., Group 2). The location of the control channel for frame N+1 may be transmitted in the control channel of frame N using methods such as the methods described above with respect to FIG. 10, FIG. 12, or any other suitable method.

At step 1420, the MS 120 preferably processes the control channel for its determined group. This processing preferably involves decoding a packet containing the control channel. At step 1430, the MS 120 preferably determines that the control channel was not successfully received, for example, by use of a cyclic redundancy check sequence. At step 1440, if the determined H-FDD group has its control channel at a variable location (e.g., is assigned to Group 2), the MS 120 preferably processes the control channel in an H-FDD group having its control channel at a fixed location (e.g., Group 1). The MS 120 then preferably determines the location of a future control channel based on the control channel at a fixed location, and then switches back to processing the control channel in an H-FDD group having its control channel at a variable location, thereby preventing the error condition from hampering further communication.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. As another example, it will be readily understood by those skilled in the art that the precise parameters of the various messages may be varied while remaining within the scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for receiving data, the method comprising:
receiving an assignment message wirelessly at a mobile station that is to be grouped into a first group, the first group being different from a second group;
receiving a first control message at the mobile station, the first control message containing an indication of a first duration, the first duration being a duration for a transmission intended for either the first group or the second group;
determining a location of a second control message from the first duration; and
receiving the second control message at the determined location.

2. The method of claim 1, wherein the transmission is intended for the second group and determining the location of the second control message further comprises adding the first duration to the beginning of a frame.

3. The method of claim 2, wherein determining the location of the second control message further comprises adding a second duration to the first duration, the second duration representing transition gaps.

4. The method of claim 1, wherein the transmission is intended for the first group and determining the location of the second control message further comprises subtracting the first duration from the total duration of a frame.

5. The method of claim 1, further comprising processing the second control message based on the determined location.

6. The method of claim 1, wherein the mobile station is part of a half duplex frequency division duplex communication system.

7. The method of claim 1, wherein the first control message has a fixed location and the second control message has a variable location.

8. A method for receiving data, the method comprising:
receiving an assignment message wirelessly at a mobile station, the assignment message indicating the that mobile station is to be assigned to a second group, the second group being different from a first group;
receiving a frame at the mobile station, the frame including a first control message and a second control message, the first control message containing an indication of a location of the second control message within the frame; and
processing the second control message.

9. The method of claim 8, wherein the indication comprises a duration of a transmission intended for either the first group or the second group, the method comprising determining the location of the second control message from the duration.

10. The method of claim 9, wherein the duration is a duration from a beginning of the frame.

11. The method of claim 9, wherein the duration is a duration from an end of the frame.

12. The method of claim 8, wherein the frame includes information between the first control message and the second control message that is not processed by mobile station.

13. A method for transmitting data, the method comprising:
transmitting a first control message comprising a first number of symbols to a first group of mobile stations and a second group of mobile stations;
determining a location of a second control message based on the first number of symbols; and
transmitting the second control message to the second group of mobile stations at the determined location.

14. The method of claim 13, wherein the first number of symbols comprises the number of symbols for a transmission to the first group of mobile stations and wherein determining the location of the second control message further comprises adding the first number of symbols to the beginning of a frame.

15. The method of claim 14, wherein determining the location of the second control message further comprises adding the transition gap symbols to the beginning of the frame and the first number of symbols.

16. The method of claim 13, wherein the first number of symbols comprises a number of symbols to be transmitted to the second group and determining the location of the second control message further comprises subtracting the number of symbols from a total number of symbols in a frame.

17. The method of claim 13, wherein the first control message has a fixed location and the second control message has a variable location.

18. The method of claim 13, further comprising processing the second control message based on the determined location.

19. A method in a base station for transmitting an indication of a frame configuration in an half duplex frequency division duplex (H-FDD) system, the method comprising:
providing a first H-FDD group and a second H-FDD group;
transmitting a frame comprising a number of OFDM symbols;
transmitting a first control message, the first control message comprising a first indication of a number of downlink symbols for the first H-FDD group relative to a beginning of the frame;
transmitting a second control message, the second control message comprising a second indication of the number of downlink symbols for the second H-FDD group relative to the end of the frame; and
retransmitting the second control message at a first location, the first location determined by subtracting the number of downlink symbols for the second H-FDD group from the number of OFDM symbols.

20. The method of claim 19, wherein the first control message and the second control message are DL-MAP messages.

21. A method for error recovery, the method comprising:
determining whether an error condition exists in a first mobile station in a first group of one or more mobile stations;
if an error condition exists, switching the first mobile station to a second group of one or more mobile stations different from the first group of mobile stations;
receiving a control message for the second group of one or more mobile stations; and
after receiving the control message, switching the first mobile station to the first group of one or more mobile stations.

22. The method of claim 21, wherein the switching is performed autonomously by the first mobile station.

23. The method of claim 21, wherein the first mobile station is part of a half duplex frequency division duplex communication system.

24. The method of claim 21, wherein the first group and second group are half duplex frequency division duplex groups.

25. A method in a mobile station for recovering from an error event in an half duplex frequency division duplex (H-FDD) system, the method comprising:
determining an H-FDD group assignment from a plurality of possible H-FDD group assignments, at least one of the H-FDD groups having a first control channel at a fixed location and at least one of the H-FDD groups having a second control channel at a variable location;
attempting to process the control channel for the determined group assignment;
determining that a control channel was not successfully received; and
if the determined H-FDD group assignment has its control channel at a fixed location, processing the control channel in the H-FDD group having its control channel at a fixed location.
